(19) United States
(12) Patent Application Publication
(10) Pub. No.: US 2006/0097033 A1
(43) Pub. Date: May 11, 2006

(54) Locking/unlocking system

(76) Inventor: Patrick Le Gal, Saint Peray (FR)

Correspondence Address: PLEVY & HOWARD, P.C., P.O. BOX 226, FORT WASHINGTON, PA, 19034, US

(21) Appl. No.: 11/268,194

(22) Filed: Nov. 7, 2005

(30) Foreign Application Priority Data
Nov. 8, 2004 (FR) 04/52559

(51) Int. Cl. G07B 15/00

(52) U.S. Cl. 232/15

(57) ABSTRACT

A system for connecting a reservoir and a container comprising, at the container level, a container opening; container closing means; and container locking means arranged to lock the container closing means in the closed position and comprising, at the reservoir level, a reservoir opening; reservoir closing means; actuation means arranged to actuate the container locking means when the container is connected to the reservoir to release the container closing means; and reservoir locking means arranged to lock said actuation means and arranged to be actuated by additional actuation means to release said actuation means connected to the reservoir, the reservoir locking means and/or said actuation means being arranged to lock the reservoir closing means in a closed position.

### BACKGROUND OF THE INVENTION

1. Field of the Invention

The present invention relates to a locking/unlocking system enabling the attachment of a reservoir to a container to transfer the content of the container into the reservoir. The present invention will be described hereafter, as an example, for the transfer of coins from a container to a reservoir.

2. Discussion of the Related Art

A device capable of dispensing coins, for example, a transportation ticket dispenser, a bill changer, a slot machine, etc. generally comprises a coin store connected to a coin dispenser. The coin store must be regularly refilled with new coins to ensure the proper operation of the device.

The coin store may be a removable store. The store is then detached from the dispenser to be filled with coins in a secure room, then brought back to the dispenser and attached thereto.

The coin store may be an enclosure which is fixed with respect to the dispenser. It is then generally manually filled by means of coin refill containers, for example, bags of coins. In this case, it is necessary to make the coin transfer from the container to the dispenser store as secure as possible by especially avoiding for someone to be able to take advantage of the transfer to take coins from the container or from the store.

### SUMMARY OF THE INVENTION

To achieve this object, the present invention aims at obtaining a system of connection between a store and a container enabling transferring items between the store and the container while preventing access to the items during the transfer.

According to another object, the present invention provides a store and a container which are of simple design and use.

For this purpose, it provides a reservoir comprising a reservoir opening for the accessing the contents of the reservoir; reservoir closing means movable between a closed position of the reservoir opening and an open position of the reservoir opening; actuation means connected to the reservoir arranged to actuate locking means distinct from the reservoir; and reservoir locking means arranged to lock the actuation means connected to the reservoir and arranged to be actuated by additional actuation means distinct from the reservoir to release the actuation means connected to the reservoir. One at least of the reservoir locking means and of the actuation means connected to the reservoir is arranged to lock the reservoir closing means in the closed position.

According to an embodiment of the present invention, the reservoir is arranged to be temporarily connected to a container for the transfer of items between the container and the reservoir, the container comprising a container opening; container closing means movable between a closed position of the container opening and an open position of the container opening; and container locking means arranged to lock the container closing means in the closed position. The reservoir opening is arranged opposite to the container opening when the container is connected to the reservoir and the actuation means connected to the reservoir are arranged to actuate the container locking means when the container is connected to the reservoir to release the container closing means.

According to an embodiment of the present invention, the actuation means connected to the reservoir comprise a key and the reservoir locking means comprise a lock cylinder.

According to an embodiment of the present invention, the reservoir further comprises a sensor arranged to detect whether the reservoir closing means is in the open position.

The present invention also provides a system for connecting a reservoir and a container for the transfer of items between the container and the reservoir. The system comprises at the container level a container opening; container closing means movable between a container opening closing position and an open position of the container opening; and container locking means arranged to lock the container closing means in the closed position. The system comprises at the reservoir level a reservoir opening, the container opening being arranged opposite to the reservoir opening when the container is connected to the reservoir; reservoir closing means movable between a reservoir opening closing position and an open position of the reservoir opening; actuation means connected to the reservoir arranged to actuate the container locking means when the container is connected to the reservoir to release the container closing means; and reservoir locking means arranged to lock the actuation means connected to the reservoir and arranged to be actuated by additional actuation means distinct from the reservoir to release the actuation means connected to the reservoir. One at least of the reservoir locking means and of the actuation means connected to the reservoir is arranged to lock the reservoir closing means in the closed position.

According to an embodiment of the present invention, the container comprises the additional actuation means.

According to an embodiment of the present invention, the additional actuation means is distinct from the container.

According to an embodiment of the present invention, the actuation means connected to the reservoir comprise a first key, the container locking means comprising a lock cylinder complementary to the first key. Further, the additional actuation means comprise a second key, the reservoir locking means comprising a lock cylinder complementary to the second key.

According to an embodiment of the present invention, the system comprises means of connection between the reservoir closing means and the container closing means arranged, on displacement of closing means from among the reservoir closing means or the container closing means, to bring the displacement of the other closing means from among the reservoir closing means and the container closing means.

The present invention also provides a method of connection between a reservoir and a container for the transfer of items between the container and the reservoir. The container comprises a container opening; container closing means movable between a container opening closing position and an open position of the container opening; and container locking means arranged to lock the container closing means in the closed position. The reservoir comprises a reservoir opening; reservoir closing means movable between a reservoir opening closing position and an open position of the reservoir opening; actuation means connected to the reservoir arranged to actuate the container locking means when the container is connected to the reservoir to release the container closing means; and reservoir locking means arranged to lock the actuation means connected to the reservoir. One at least of the reservoir locking means and of the actuation means connected to the reservoir is arranged to lock the reservoir closing means in the closed position. The method comprises the steps of placing the container at the reservoir level so that the container opening is arranged opposite to the reservoir opening; actuating the reservoir closing means by additional actuation means distinct from the reservoir to release the actuation means connected to the reservoir; actuating the actuation means connected to the reservoir to release the reservoir locking means; and displacing the reservoir and container closing means to respectively the open position of the reservoir opening and the open position of the container opening.

The foregoing and other objects, features, and advantages of the present invention will be discussed in detail in the following non-limiting description of specific embodiments in connection with the accompanying drawings.

### BRIEF DESCRIPTION OF THE DRAWINGS

FIG. 1 schematically shows a coin store and a coin container according to a first example of embodiment of the present invention;

FIG. 2 is a more detailed cross-section view of a portion of the container and of the store according to the first example of embodiment; and

FIG. 3 is a more detailed cross-section view of a portion of the container and of the store according to a second example of embodiment.

### DETAILED DESCRIPTION

For clarity, same elements have been designated with same reference numerals in the different drawings.

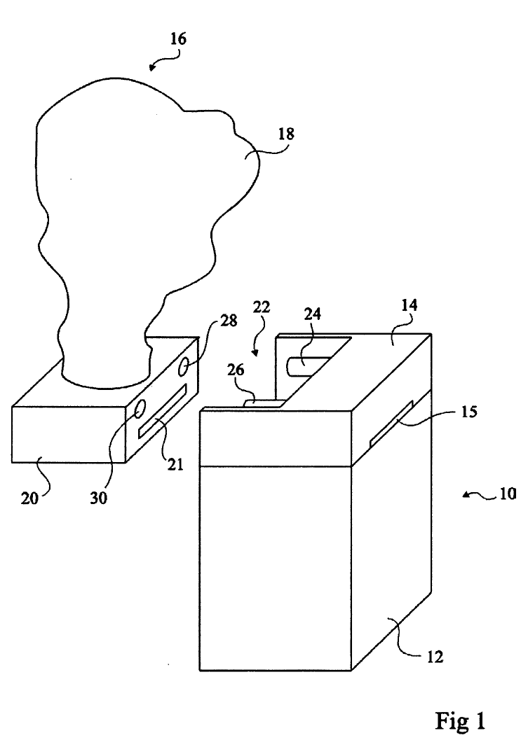

FIG. 1 shows a coin store 10 of a device, not entirely shown, capable of dispensing coins to a user. It is for example a ticket dispenser, a bill exchanger, a slot machine, etc. Store 10 comprises an enclosure 12 topped with a base 14 comprising an opening, not visible in FIG. 1, enabling access to the content of enclosure 12 and closable by a drawer 15.

To refill store 12 with coins, a coin refill 16 comprising a bag 18, or a rigid box, containing the coins, open at one end at the level of an access system 20 is used. Access system 20 comprises an opening, not visible in FIG. 1, enabling access to the content of bag 18 and that can be closed by a drawer 21.

Base 14 comprises a recess 22 arranged to receive a portion of access system 20. When base 14 receives access system 20, the opening of access system 20 is placed opposite to the opening of base 14. According to the first embodiment of the present invention, base 14 comprises two protrusions 24, 26 arranged to cooperate with corresponding recesses 28, 30 at the level of access system 20. When access system 20 is at a distance from base 14, each drawer 15, 21 is in closed position, preventing access to the content, respectively, of enclosure 12 and of bag 18.

On arranging of access system 20 at the level of base 14, protrusions 24, 26 are introduced into recesses 28, 30. As will be described in further detail hereafter, the user can then lock access system 20 on base 14. Only when access system 20 is locked on base 14 can drawers 15, 21 be actuated, enabling communication between the content of bag 18 and the content of reservoir 12 for the coin transfer from bag 18 into enclosure 12.

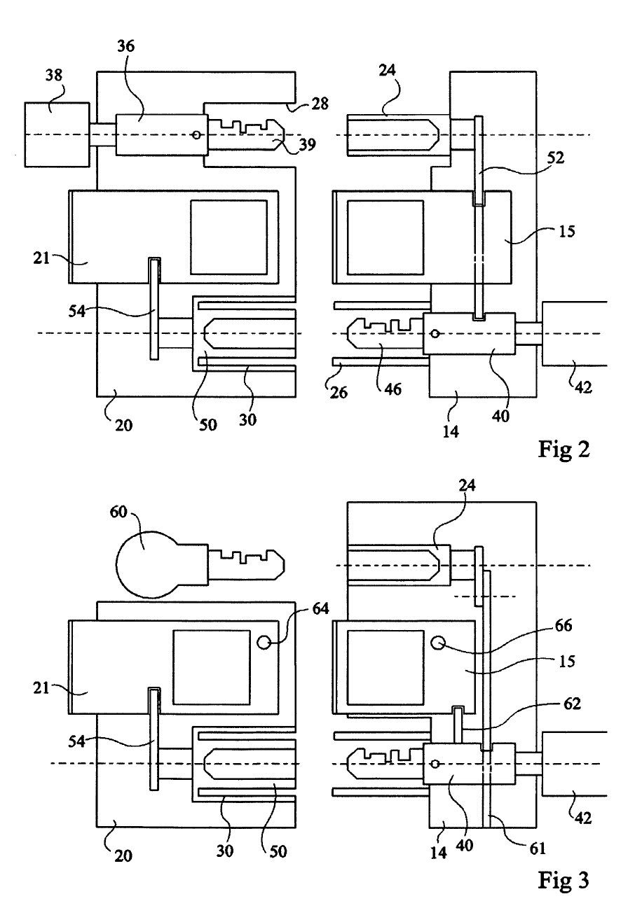

FIG. 2 is a cross-section view of access system 20 and of base 14 according to the first example of embodiment. Access system 20 comprises a key 36 that can be actuated by a user via a thumb wheel 38 and comprising an end 39, emerging into recess 28 and supporting, for example, a bit or notches. Recess 28 enables protecting the end of key 36. Protrusion 24 of base 14 corresponds to a lock cylinder arranged to cooperate with the end 39 of key 36. When end 39 of key 36 is not introduced into lock cylinder 24, lock cylinder 24 is blocked in a so-called closed position. When end 39 of key 36 is introduced into lock cylinder 24, lock cylinder 24 can be rotated by key 36 from the closed position to a so-called open position. When lock cylinder 24 is in open position, key 36 cannot be taken out of lock cylinder 24.

Base 14 comprises a key 40 that can be actuated by the user via a thumb wheel 42 and comprising an end 46 comprising, for example, a bit or notches. Protrusion 26 has a hollow cylindrical shape surrounding end 46 of key 40 to protect it. A lock cylinder 50 is placed in recess 30 and is arranged to cooperate with end 46 of key 40. When end 46 of key 40 is not introduced into lock cylinder 50, lock cylinder 50 is blocked in a so-called closed position. When end 46 of key 40 is introduced into lock cylinder 50, lock cylinder 50 can be rotated by key 40 from the closed position to a so-called open position. When lock cylinder 50 is in open position, key 40 can no longer be taken out of lock cylinder 50.

Lock cylinder 24 of base 14 is capable of driving a transmission mechanism 52 which, when lock cylinder 24 is in closed position, blocks key 40 in rotation and prevents the sliding of drawer 15, drawer 15 then being in the position preventing the access to the content of enclosure 12. When lock cylinder 24 is rotated to the open position, it actuates transmission system 52 which then no longer prevents the rotation of key 40 and the sliding of drawer 15. When drawer 15 is in a position enabling access to the content of enclosure 12, lock cylinder 24 cannot be brought back from the open position to the closed position. Lock cylinder 50 of access system 20 is capable of actuating a transmission system 54 which, when lock cylinder 50 is in closed position, prevents the sliding of drawer 21, drawer 21 then being in the position preventing access to the content of bag 18. When lock cylinder 50 is rotated to the open position, it actuates transmission system 54 which then no longer prevents the sliding of drawer 21. When drawer 21 is in a position enabling access to the content of bag 18, lock cylinder 50 cannot be brought back from the open position to the closed position. Transmission systems 52, 54 are for example formed of an assembly of cams, levers, and pivots and will not be described in further detail hereafter.

The transfer of coins from bag 18 into enclosure 12 according to the first example of embodiment is obtained by placing access system 20 at the level of base 14, which causes the introduction of end 39 of key 36 into lock cylinder 24, then in closed position, and the introduction of end 46 of key 40 into lock cylinder 50, also in closed position. Key 36 is then actuated via thumb wheel 38 rotating lock cylinder 24 from the closed position to the open position, which then actuates transmission system 52, thus freeing the sliding of drawer 15 and the rotation of key 40. Key 36 cooperating with lock cylinder 24 in open position, it is then not possible to withdraw access system 20 from base 14. Key 40 is then actuated via thumb wheel 42 rotating lock cylinder 50 from the closed position to the open position, which then actuates transmission system 54, thus freeing the sliding of drawer 21. The user can then slide drawers 15, 21 enabling transfer of coins from bag 18 into enclosure 12.

The withdrawal of access system 20 from base 14 is performed by closing back drawers 21, 15. Key 40 is then actuated to bring lock cylinder 50 from the open position to the closed position. Drawer 21 is then blocked by transmission system 54. Key 36 is then actuated to bring lock cylinder 24 back from the open position to the closed position and thus prevent the sliding of drawer 15 and the rotation of key 40. Lock cylinders 24 and 50 both being in closed position, access system 20 can then be taken out of base 14. Further, both drawers 15, 21 being blocked in the position closing the access, respectively, to bag 18 and to enclosure 12, a user does not have access to the coins present in bag 18 or in enclosure 12.

Recess 28 and protrusion 26 are arranged on the one hand to mechanically protect against shocks, respectively, ends 39, 46 of keys 36, 40 and, on the other hand, to hide each end 39, 46 of keys 36, 40 to limit copying attempts. Ends 39, 46 of keys 36, 40 may easily be replaced in a workshop after disassembling of base 14 and of access system 20 to enable replacement of worn keys or change of key number in case of a fraud or of a change in the park of coin stores 10.

FIG. 3 shows a second more detailed example of embodiment of access system 20 and of base 14.

Conversely to the first example of embodiment, access system 20 comprises no key. The user has a separate key 60 capable of cooperating with lock cylinder 24 of base 14. Lock cylinder 24 of base 14 is capable of driving a main transmission system 61 which, when lock cylinder 24 is in closed position, blocks key 40 in rotation. When lock cylinder 24 is rotated to the open position, it actuates main transmission system 61 to enable rotation of key 40. Key 40 is connected to drawer 15 by a secondary transmission system 62 so that, when key 40 is blocked in rotation by main transmission system 61, the sliding of drawer 15 is prevented by secondary transmission system 62, drawer 15 then being in the position preventing access to the content of enclosure 12. When drawer 15 is in the position enabling access to the content of enclosure 12, key 40 can no longer be actuated. Lock cylinder 50 of access system 20 is connected to drawer 21 by transmission system 54, similarly to what has been previously described in relation with the first example of embodiment. When drawer 21 is in a position enabling access to the content of bag 18, lock cylinder 50 can no longer be brought from the open position to the closed position. Drawer 21 comprises a pin 64 and drawer 15 comprises a movable pin 66 of complementary shape that can be displaced between an engagement position at which pin 66 cooperates with pin 64 and a non-engagement position in which pin 66 does not cooperate with pin 64. The displacement of pin 66 is performed via secondary transmission system 62 so that pin 66 is in a non-engagement position when secondary transmission system 62 blocks the sliding of drawer 15 and in engagement position when secondary transmission system 62 does not block the sliding of drawer 15. When pins 64, 66 cooperate, the sliding of one of pins 15, 21 causes the sliding of the other drawer.

According to a variation of the second example of embodiment, main and secondary transmission systems 61 and 62 are replaced by transmission system 52 of the first example of embodiment which, when lock cylinder 24 is in closed position, simultaneously prevents the rotation of key 40, the sliding of drawer 15, and maintains pin 66 in non-engagement position.

The transfer of coins from bag 18 into enclosure 12 according to the second example of embodiment is obtained by placing access system 20 on base 14, key 40 penetrating into lock cylinder 50. Lock cylinders 24, 50 then are in closed position. However, at this time, the rotation of key 40 is prevented by transmission system 61. The user then introduces key 60 into lock cylinder 24 and rotates lock cylinder 24 from the closed position to the open position. This motion frees the rotation of key 40. The user can then actuate key 40, which frees the sliding of drawer 15 and causes the displacement of pin 66 from the non-engagement position to the engagement position. Pin 66 then cooperates with pin 64. The rotation of lock cylinder 50 frees the sliding of drawer 21. The user can then slide drawer 21, which causes the sliding of drawer 15, enabling transfer of coins from bag 18 into enclosure 12.

The withdrawal of access system 20 from base 14 is performed by closing one of drawers 15, 21, which closes the other drawer, and by actuating key 40 to bring lock cylinder 50 back from the open position to the closed position. Drawer 21 is then blocked by transmission system 54 and drawer 15 is blocked by secondary transmission system 62. Lock cylinder 50 being in closed position, access system 20 can be withdrawn from base 14. Key 60 is then actuated to bring lock cylinder 24 back from the open position to the closed position and thus block the rotation of key 40. Key 60 is then taken out. Lock cylinder 24 being in closed position, the rotation of key 40 is blocked and drawer 15 is maintained in blocked position.

As for the first example of embodiment, the opening of drawer 21 is only possible when access system 20 is placed on base 14, which prevents any access to the content of bag 18 when access system 20 is not placed at the level of base 14. However, when access system 20 is not placed at the level of base 14, a user can introduce key 60 into lock cylinder 24 to free the rotation of key 40, the actuation of which enables sliding drawer 15. A user could thus, by sliding drawer 15, have access to the content of enclosure 12. To avoid any fraudulent access to the content of enclosure 12, a detector may be provided at the level of base 14 to determine whether drawer 15 is in open or closed position. Access system 20 cannot be placed on base 14 when drawer 15 is open, since key 40 which has been actuated to free the sliding of drawer 15 cannot be introduced into lock cylinder 50 in closed position. Thereby, if an operator having key 60 tried to fraudulently access to the content of enclosure 12 in a coin store refill operation, he should slide drawer 15 twice, a first time to refill enclosure 12 with coins and a second time to fraudulently have access to the content of enclosure 12. The abnormal number of openings of drawer 15 would then be detected. Since an enclosure refill operation is generally preceded by a step of identification of the operator in charge of the refill via a man/machine interface provided at the dispenser level, the operator having performed the fraudulent operation would then be known.

The second example of embodiment of the present invention has the advantage of an easier, less expensive forming of access system 20.

Of course, the present invention is likely to have various alterations, modifications, and improvements which will readily occur to those skilled in the art. In particular, the shown transmission systems are mechanical. However, electromechanical transmission systems comprising, for example, for base 14, a sensor adapted to determining the position of lock cylinder 24 and of controlling an electrovalve which, according to the detected position of the lock cylinder, prevents or not the rotation of key 40, may be used.

Such alterations, modifications, and improvements are intended to be part of this disclosure, and are intended to be within the spirit and the scope of the present invention. Accordingly, the foregoing description is by way of example only and is not intended to be limiting. The present invention is limited only as defined in the following claims and the equivalents thereto.

What is claimed is:

1. A reservoir (10) comprising:
a reservoir opening for accessing the contents of the reservoir;
reservoir closing means (15) movable between a closed position of the reservoir opening and an open position of the reservoir opening;
actuation means connected to the reservoir (40) arranged to actuate locking means (50, 54) distinct from the reservoir; and
reservoir locking means (24, 52, 61) arranged to lock the actuation means connected to the reservoir and arranged to be actuated by additional actuation means (36, 60) distinct from the reservoir to release the actuation means connected to the reservoir,
wherein at least one of the reservoir locking means and the actuation means connected to the reservoir is arranged to lock the reservoir closing means in the closed position.

2. The reservoir of claim 1, suitable for being temporarily connected to a container (16) for the transfer of items between the container and the reservoir,
the container comprising:
a container opening;
container closing means (21) movable between a closed position of the container opening and an open position of the container opening; and
container locking means (50, 54) arranged to lock the container closing means in the closed position,
wherein the reservoir opening is arranged opposite to the container opening when the container is connected to the reservoir and wherein the actuation means connected to the reservoir (40) is arranged to actuate the container locking means when the container is connected to the reservoir to release the container closing means.

3. The reservoir of claim 1, wherein the actuation means connected to the reservoir (40) comprise a key and the reservoir locking means (24) comprise a lock cylinder.

4. The reservoir of claim 1, further comprising a sensor arranged to detect whether the reservoir closing means (15) is in the open position.

5. A system for connecting a reservoir (10) and a container (16) for the transfer of items between the container and the reservoir,
comprising at the container level:
a container opening;
container closing means (21) movable between a closed position of the container opening and an open position of the container opening; and
container locking means (50, 54) arranged to lock the container closing means in the closed position, and comprising at the reservoir level:
a reservoir opening, the container opening facing the reservoir opening when the container is connected to the reservoir;
reservoir closing means (15) movable between a closed position of the reservoir opening and an open position of the reservoir opening;
actuation means connected to the reservoir (40) arranged to actuate the container locking means when the container is connected to the reservoir to release the container closing means; and
reservoir locking means (24) arranged to lock the actuation means connected to the reservoir and arranged to be actuated by additional actuation means (36, 60) distinct from the reservoir to release the actuation means connected to the reservoir,
wherein at least one of the reservoir locking means and of the actuation means connected to the reservoir is arranged to lock the reservoir closing means in the closed position.

6. The system of claim 5, wherein the container (16) comprises said additional actuation means (36).

7. The system of claim 5, wherein said additional actuation means (60) is distinct from the container (16).

8. The system of claim 5, wherein the actuation means connected to the reservoir (40) comprise a first key, the container locking means (50, 54) comprising a lock cylinder complementary to the first key, and wherein the additional actuation means (36, 60) comprise a second key, the reservoir locking means (24, 52, 61, 62) comprising a lock cylinder complementary to the second key.

9. The system of claim 5, comprising means of connection between the reservoir closing means (15) and the container closing means (21) arranged, on displacement of closing means from among the reservoir closing means or the container closing means, to cause the displacement of the other closing means from among the reservoir closing means and the container closing means.

10. A method of connection between a reservoir (10) and a container (16) for the transfer of items between the container and the reservoir, the container comprising:
a container opening;
container closing means (21) movable between a closed position of the container opening and an open position of the container opening; and
container locking means (50, 54) arranged to lock the container closing means in the closed position, the reservoir comprising:
a reservoir opening;
reservoir closing means (15) movable between a closed position of the reservoir opening and an open position of the reservoir opening;
actuation means connected to the reservoir (40) arranged to actuate the container locking means when the container is connected to the reservoir to release the container closing means; and
reservoir locking means (24) arranged to lock the actuation means connected to the reservoir,
wherein one at least of the reservoir locking means and of the actuation means connected to the reservoir is arranged to lock the reservoir closing means in the closed position,
the method comprising the steps of:
placing the container at the reservoir level so that the container opening faces the reservoir opening;
actuating the reservoir closing means by additional actuation means (36, 60) distinct from the reservoir to release the actuation means connected to the reservoir;
actuating the actuation means connected to the reservoir to release the reservoir locking means; and
displacing the reservoir and container closing means to respectively the open position of the reservoir opening and the open position of the container opening.
